(19) United States
(12) Patent Application Publication
(10) Pub. No.: US 2011/0298694 A1
(43) Pub. Date: Dec. 8, 2011

(54) ELECTROLUMINESCENT DISPLAY PANEL AND PIXEL STRUCTURE THEREOF

(76) Inventor: Chien-Ming Nieh, Hsin-Chu (TW)

(21) Appl. No.: 12/882,207

(22) Filed: Sep. 15, 2010

(30) Foreign Application Priority Data
Jun. 3, 2010 (TW) 099117948

(51) Int. Cl. G09G 3/30

(52) U.S. Cl. 345/76

(57) ABSTRACT

An electroluminescent (EL) display panel includes a blue EL device, a red EL device, a green EL device, a first power line electrically connected to the blue EL device, a second power line electrically connected to the red EL device, and a third power line electrically connected to the green EL device. The first power line has a first width, the second power line has a second width, and the third power line has a third width, wherein the first width is larger than the second width and the first width is larger than the third width.

### BACKGROUND OF THE INVENTION

1. Field of the Invention

The present invention relates to an electroluminescent (EL) display panel and related pixel structure, and more particularly, to an electroluminescent display panel and pixel structure with a design of different widths of power lines.

2. Description of the Prior Art

The electroluminescent display, due to its properties such as slim size, light weight, high resolution, high contrast, economically power-consuming, and spontaneously light-emitting, has gradually replaced the liquid crystal display to become the mainstream product in next generation of flat panel displays.

FIG. 1 illustrates an electric circuit structure of a pixel structure of a conventional electroluminescent display panel. As shown in FIG. 1, the conventional electroluminescent display panel 10 includes a plurality of pixel structures 12, and each pixel structure 12 includes a pixel switch device 14, a driver switch device 16, a storage capacitor Cs, and an electroluminescent device EL. The gate, the source, and the drain of the pixel switch device 14 are electrically connected respectively to a scanning line SL, a data line DL, and the gate of the driver switch device 16. The source and the drain of the driver switch device 16 are electrically connected respectively to a voltage OVDD of the power line PL and an end of the electroluminescent device EL. The storage capacitor Cs is electrically connected respectively to the gate of the driver switch 16 and the voltage OVDD of the power line PL. The other end of the electroluminescent device EL is electrically connected to a voltage OVSS of the power line PL.

Each of the pixel structures 12 of the electroluminescent display panel 10 connects to each other. A current I is generated and flows through the power line PL when the light emitting is processing. However, a voltage dropping is occurred because of the resistance of the power line PL. The pixel structure 12 which is closer to the voltage OVDD has the lower voltage dropping due to the lower resistance of the power line PL; on the other hand, the pixel structure 12 which is far from the voltage OVDD has a higher voltage dropping due to the higher resistance of the power line PL. Consequently, the pixel structures 12 in different positions have current difference, contributing to different brightness of the electroluminescent device EL and the non-uniform brightness of the electroluminescent display panel 10.

Further, all the power lines PL of the conventional electroluminescent display panel 10 have consistent widths, in other words, each resistance of the power line PL is equal to each other. Because of the diverse light emitting properties of different luminescent materials, for instance, the different light emitting efficiencies of a blue electroluminescent device, a red electroluminescent device, and a green electroluminescent device (generally, the light emitting efficiency of the blue electroluminescent device is lower than the light emitting efficiencies of the red electroluminescent device and the green electroluminescent device), and because of the different receptions of the diverse colored lights to the eyes, the uni-width of the power lines PL increases the total voltage dropping of the conventional electroluminescent display panel 10, which leads to the non-uniform brightness of the electroluminescent display panel 10.

### SUMMARY OF THE INVENTION

It is therefore one of the objectives of the present invention to provide an electroluminescent display device and a pixel structure thereof to solve the voltage dropping of the power lines.

In accordance with an embodiment of the present invention, an electroluminescent display panel comprises a substrate, a plurality of scanning lines, a plurality of data lines, a plurality of electroluminescent devices, and a plurality of power lines. The scanning lines are disposed on the substrate and arranged substantially in parallel to each other in a first direction, and the data lines are disposed on the substrate and arranged substantially in parallel to each other in a second direction. The data lines and the scanning lines at least define a plurality of blue sub-pixel areas, a plurality of red sub-pixel areas, and a plurality of green sub-pixel areas arranged in the second direction. The electroluminescent devices comprise a plurality of blue electroluminescent devices disposed in the blue sub-pixel areas, a plurality of red electroluminescent devices disposed in the red sub-pixel areas, and a plurality of green electroluminescent devices disposed in the green sub-pixel areas. The power lines comprise at least a first power line, a second power line, and a third power line. The first power line is disposed on the substrate, arranged in the second direction, and electrically connected to the blue electroluminescent device and has a first width. The second power line is disposed on the substrate, arranged in the second direction, and electrically connected to the red electroluminescent device and has a second width. The third power line is disposed on the substrate, arranged in the third direction, and electrically connected to the green electroluminescent device and has a third width. The first width is larger than the second width, and the first width is larger than the third width.

In accordance with another embodiment of the present invention, a pixel structure disposed on a substrate which defines a blue sub-pixel area, a red sub-pixel area, and a green sub-pixel area is provided. The pixel structure comprises a blue electroluminescent device disposed in the blue sub-pixel area, a red electroluminescent device disposed in the red sub-pixel area, a green electroluminescent device disposed in the green sub-pixel area, a first power line disposed on the substrate and electrically connected to the blue electroluminescent device, a second power line disposed on the substrate and electrically connected to the red electroluminescent device, and a third power line disposed on the substrate and electrically connected to the green electroluminescent device. The first power line has a first width, the second power line has a second width, and the third power line has a third width. The first width is larger than the second width and the first width is larger than the third width.

In accordance with still another embodiment of the present invention, a pixel structure disposed on a substrate which defines a first pixel area, a second pixel area, and a third pixel area is provided. The pixel structure comprises a first electroluminescent device, a second electroluminescent device, a third electroluminescent device, a first power line, a second power line, and a third power line. The first electroluminescent device is disposed in the first sub-pixel area for emitting a first color light with a first wavelength. The second electroluminescent device is disposed in the second sub-pixel area for emitting a second color light with a second wavelength. The third electroluminescent device is disposed in the third sub-pixel area for emitting a third color light with a third wavelength. The first power line is disposed on the substrate and electrically connected to the first electroluminescent device, wherein the first power line has a first width. The second power line is disposed on the substrate and electrically connected to the second electroluminescent device, wherein the second power line has a second width. The third power line is disposed on the substrate and electrically connected to the third electroluminescent device, wherein the third power line has a third width. The first wavelength is less than the second wavelength and the first wavelength is less than the third wavelength. The first width is larger than the second width and the first width is larger than the third width.

In the present invention, the electroluminescent display panel and the pixel thereof have the power lines with different width able to reduce the total voltage dropping of the power lines effectively and able to improve the brightness uniformity without affecting the aperture ratio.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an electric circuit structure of a pixel structure of a conventional electroluminescent display panel.

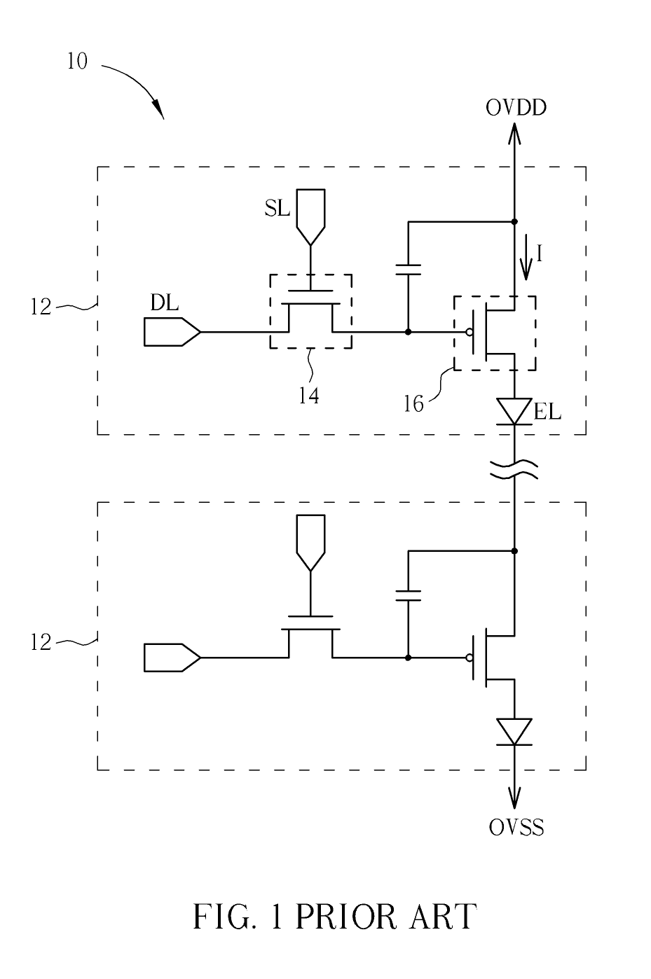

FIG. 2 illustrates an electroluminescent display panel according to a preferred embodiment of the present invention.

FIG. 3 is a sectional diagram illustrating a part of the pixel structure of the electroluminescent display panel of the FIG. 2.

FIG. 4 is a cross-sectional view of the pixel structure of the electroluminescent display panel taken along line A-A′ in FIG. 3.

FIG. 5 illustrates an electroluminescent display panel of another preferred embodiment of the present invention.

### DETAILED DESCRIPTION

To provide a better understanding of the present invention, preferred embodiments will be made in details. The preferred embodiments of the present invention are illustrated in the accompanying drawings with numbered elements.

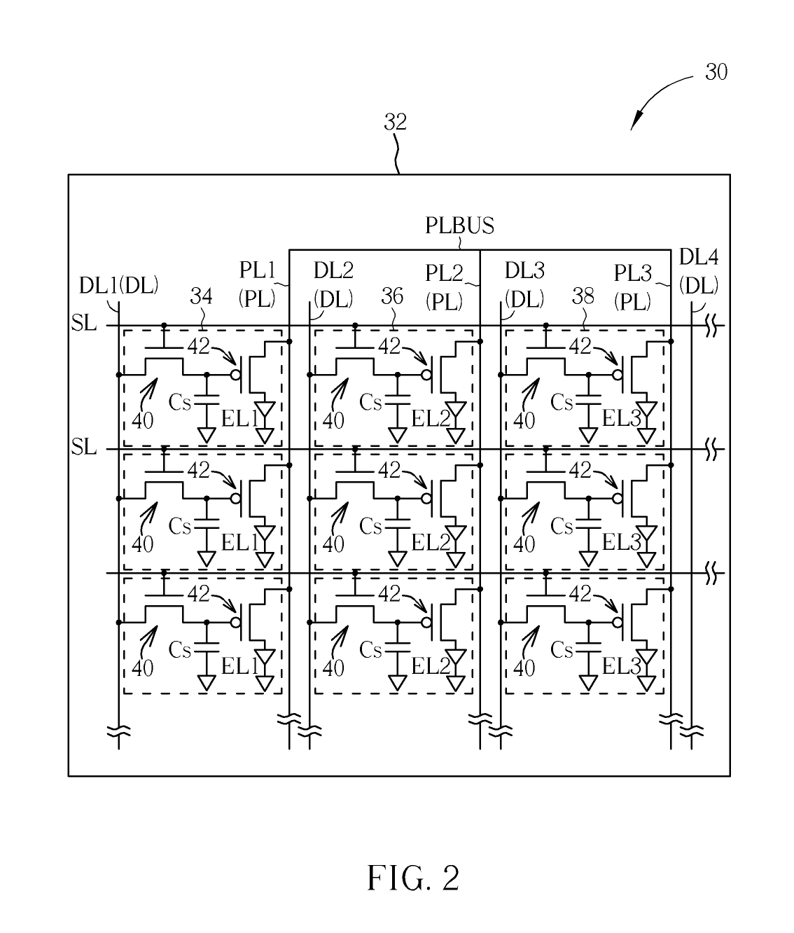

FIG. 2 illustrates an electroluminescent display panel according to a preferred embodiment of the present invention. In the present invention, the electroluminescent display panel could be an organic light-emitting diode (OLED) display, polymer light emitting diode display (PLED), or any other types of the electroluminescent display panels. As shown in FIG. 2, the electroluminescent display panel 30 of the present embodiment includes a substrate 32, a plurality of scanning lines SL, and a plurality of data lines DL. The scanning lines SL are disposed on the substrate 32 and substantially arranged in parallel to each other along a first direction, and the data lines DL are disposed on the substrate 32 and substantially arranged in parallel to each other along a second direction. In the present embodiment, the first direction is substantially perpendicular to the second direction, for example, the first direction shown in FIG. 2 could be a horizontal direction and the second direction shown in FIG. 2 could be the vertical direction; but not limited thereto. The data lines DL and the scanning lines SL at least define a plurality of a first pixel area 34, a second pixel area 36, and a third pixel area 38 arranged in the second direction on the substrate 32. Precisely, the first pixel areas 34, the second pixel areas 36, and the third pixel areas 38 are arranged alternately and repeatedly in stripe. For instance, there are a plurality of the first pixel areas 34 disposed between the first data line DL1 and the second data line DL2, a plurality of the second pixel areas 36 disposed between the second data line DL2 and the third data line DL3, and a plurality of the third pixel areas 38 disposed between the third data line DL3 and the fourth data line DL4, and so on. Moreover, the first pixel area 34, the second pixel area 36, and the third pixel area 38 are configured to dispose the electroluminescent devices of different colors.

The electroluminescent display panel 30 of the present embodiment further comprises a plurality of electroluminescent devices, such as a plurality of first electroluminescent device EL1, a plurality of second electroluminescent devices EL2, and a plurality of third electroluminescent devices EL3. Each the first electroluminescent device EL1 is respectively disposed in the first sub-pixel area 34 for emitting a first colored light with a first wavelength, each the second electroluminescent device EL2 is respectively disposed in the second sub-pixel area 36 for emitting a second colored light with a second wavelength, and each the third electroluminescent device EL3 is respectively disposed in the third sub-pixel area 38 for emitting a third colored light with a third wavelength. The first wavelength of the first colored light is shorter than the second wavelength of the second colored light, and the first wavelength of the first colored light is shorter than the third wavelength of the third colored light. In the embodiment of the present invention, for instance, the first pixel area 34 could be a blue sub-pixel area B and the first electroluminescent device could be a blue electroluminescent device, therefore, the first colored light is blue and the first wavelength is between 420 nm to 490 nm; the second pixel area 36 could be a red sub-pixel area R and the second electroluminescent device EL2 could be a red electroluminescent device, therefore, the second colored light is red and the second wavelength is between 630 nm to 780 nm; the third pixel area 38 could be a green sub-pixel area G and the third electroluminescent device EL3 could be a green electroluminescent device, therefore, the third colored light is green and the third wavelength is between 490 nm to 630 nm. It is to be noted that the range of the wavelength mentioned above is exemplary, but have no way to limit the range of the wavelength of each colored light in the present invention. The detail structure of the electroluminescent device mentioned above is well known, thus is not redundantly described.

The electroluminescent display panel 30 of the present embodiment further comprises a plurality of power lines PL disposed on the substrate 32 and arranged in alternately with the data lines DL. The power lines PL may include a plurality of first power lines PL1, a plurality of second power lines PL2, and a plurality of third power lines PL3, wherein the first power lines PL1 are electrically connected to the first electroluminescent devices EL1, the second power lines PL2 are electrically connected to the second electroluminescent devices EL2, and the third power lines PL3 are electrically connected to the third electroluminescent devices EL3. Moreover, in this embodiment, the first power lines PL1, the second power lines PL2, and the third power lines PL3 are electrically connected to a single power bus line PLBUS to receive the voltage signal from the power bus line PLBUS.

The electroluminescent display panel 30 of the present embodiment further includes a plurality of first switch devices 40, a plurality of second switch devices 42, and a plurality of storage capacitors Cs which are disposed in the first pixel areas 34, the second pixel areas 36, and the third pixel areas 38, wherein the first switch devices 40 are used as the pixel switch devices, and the second switch devices 42 are used as the driver switch devices. The gate of each first switch device 40 is electrically connected to the corresponding scanning line SL, and the source of each first switch device 40 is electrically connected to the corresponding data line DL. Also, the gate of each second switch device 42 is electrically connected to the corresponding drain of the first switch device 40, the source of each second switch device 42 is electrically connected to the corresponding electroluminescent device, and the drain of each second switch device 42 is electrically connected to the corresponding power line PL. This embodiment is used to exemplify the pixel structure but not a limitation; the skilled of the art can adjust the structure as required.

In this embodiment, the first electroluminescent device EL1 (the blue electroluminescent device) has a first light emitting efficiency, the second electroluminescent device EL2 (the red electroluminescent device) has a second light emitting efficiency, and the third electroluminescent device EL3 (the green electroluminescent device) has a third light emitting efficiency. The first light emitting efficiency is lower than the second light emitting efficiency, and the first light emitting efficiency is lower than the third light emitting efficiency. Take the same luminescent device structure for example, the blue electroluminescent device uses (TBP; 2,5,8,11-tetra-terbutylperylene) as its luminescent material, the green electroluminescent device uses (Ir(ppy)3; iridium(III) cyclometalated fac-tris(2-phenylpyridine)) as its luminescent material, and the red uses (Ir(piq)3; fac-tris(1-phenylisoquinolinato-N,C 2′)iridium(III)) as its luminescent material. Consequently, the first light emitting efficiency of the blue electroluminescent device is approximately 3.5 cd/A, the second light emitting efficiency of the red electroluminescent device is approximately 10 cd/A, and the third light emitting efficiency of the green electroluminescent device is approximately 28 cd/A. In other words, the first light emitting efficiency is lower than the second light emitting efficiency, and the second light emitting efficiency is lower than the third light emitting efficiency. The embodiment mentioned above describes that the light emitting efficiency of the blue electroluminescent is generally lower than the light emitting efficiency of the red electroluminescent and the light emitting efficiency of the green electroluminescent. The luminescent material is not limited to the aforementioned materials. For example, the second light emitting efficiency of some other types of the red electroluminescent devices is higher than the third light emitting efficiency of the green electroluminescent devices. Those skilled may choose other appropriate materials to match the required light emitting efficiency. In order to match the light emitting efficiency of different colors to achieve the balance of colors, and to improve the uniformity of the display panels, the present invention employs the inverse proportion relation between the current of the electroluminescent device and the light emitting efficiency thereof, that is, the required current of the electroluminescent device with high light emitting efficiency (such as the green electroluminescent device) is lower than the required current of the electroluminescent device with low light emitting efficiency (such as the blue electroluminescent device). In this embodiment of the present invention, because the first light emitting efficiency is lower than the second light emitting efficiency and the second light emitting efficiency is lower than the third light emitting efficiency, the current of the first electroluminescent device EL1 is larger than the current of the second electroluminescent device EL2 and the current of the second electroluminescent device EL2 is larger than the current of the third electroluminescent device EL3.

As the mention above, the power line PL has the resistance and results in a voltage dropping which is the product of the value of the current and the value of the resistance, thus the higher value of current generates the larger voltage dropping when the values of the resistance are the same. In other words, if the first power line PL1, the second power line PL2, and the third power line PL3 have the same resistance r, and the currents of the first power line PL1, the second power line PL2, and the third power line PL3 are I1, I2, and I3, respectively, the voltage dropping (I1*r) of the first power line PL1 is larger than the voltage dropping (I2*r) of the second power line PL2, and the voltage dropping (I2*r) of the second power line PL2 is larger than the voltage dropping (I3*r) of the third power line PL3. Accordingly, for the power lines with different currents, if each power line has identical resistance, the voltage droppings of each power line are different and result in non-uniformity of the brightness. The present invention adjusts the ratio of the width of the first power line PL1, the second power line PL2, and the third power line PL3 based on the different currents of the first power line PL1, the second power line PL2, and the third power line PL3, so that the first power line PL1, the second power line PL2, and the third power line PL3 have different resistances. As a result, the total voltage dropping of the electroluminescent display panel 30 is reduced, thereby resolving the non-uniformity of the brightness. The method of adjusting the first power line PL1, the second power line PL2, and the third power line in the present invention is described as follows.

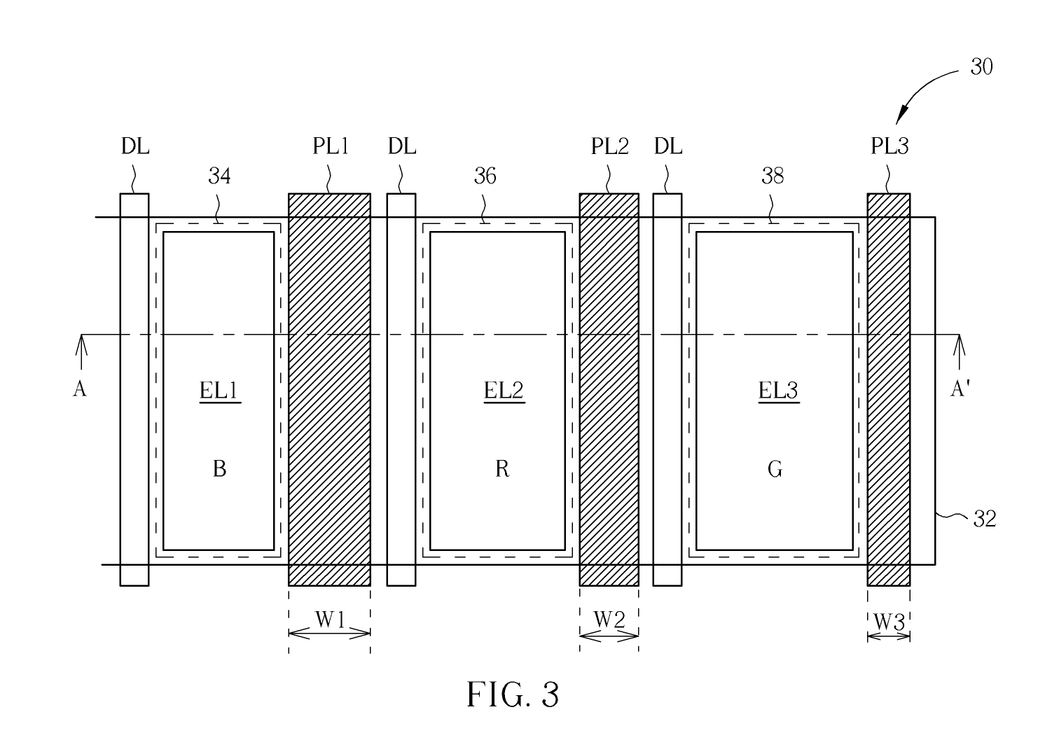

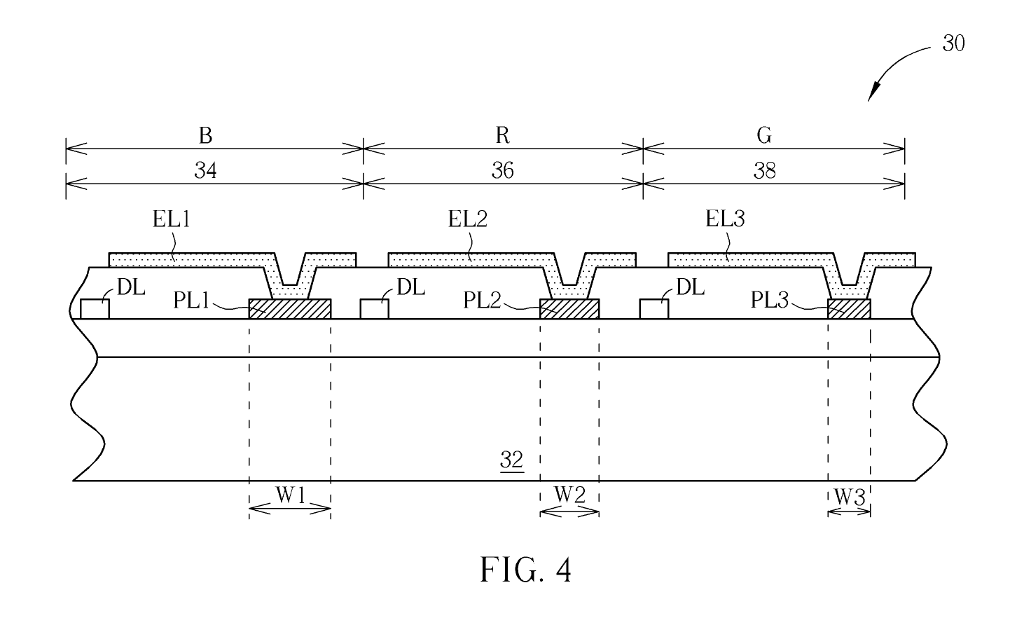

Please refer to the FIG. 3 and FIG. 4, as well as FIG. 2. FIG. 3 is a sectional diagram illustrating a part of the pixel structure of the electroluminescent display panel of the FIG. 2 and FIG. 4 is a cross-sectional view of the pixel structure of the electroluminescent display panel taken along line A-A′ in FIG. 3. As shown in FIG. 3 and FIG. 4, in the embodiment of the present invention, the first electroluminescent device EL1 as the blue electroluminescent device, the first sub-pixel area 34 as the blue sub-pixel area B, the second electroluminescent device EL2 as the red electroluminescent device, the second sub-pixel area 36 as the red sub-pixel area R, the third electroluminescent device EL3 as the green electroluminescent device, and the third sub-pixel area 38 as the green sub-pixel area G are for the exemplification but not for the limitation. The first power line PL1 has a first width W1, the second power line PL2 has a second width W2, and the third power line PL3 has a third width W3. In the embodiment of the present invention, the first width W1 is larger than the second width W2 and the first width W1 is larger than the third width W3. As mentioned, the first power line PL1 is electrically connected to the first electroluminescent device EL1, the second power line PL2 is electrically connected to the second electroluminescent device EL2, and the third power line PL3 is electrically connected to the third electroluminescent device. In the circumstance that the first light emitting efficiency of the first electroluminescent device is less than the second light emitting efficiency of the second electroluminescent device and the second light emitting efficiency of the second electroluminescent device is less than the third light emitting efficiency of the third electroluminescent device, the current of the first power line PL1 is larger than the current of the second power line PL2 and the current of the second power line PL2 is larger than the current of the third power line PL3. Therefore, the first width W1 is designed to be larger than the second width W2 and the second width W2 is designed to be lager than the third width W3 in the embodiment of the present invention. For example, if the current ratio of the first power line PL1, the second power line PL2 and the third power line PL3 is 3:2:1 (i.e. PL1:PL2:PL3=3:2:1), the ratio of the first width W1, the second width W2 and the third width is substantially set as 7:5:3 (i.e. W1:W2:W3=7:5:3). Because the width of the line is inversely proportional to the resistance of the line, the ratio of the first resistance R1 of the first power line PL1, the second resistance R2 of the second power line PL2 and the third resistance R3 of the third power line PL3 is substantially 1/7:1/5:1/3, which is equals to 15:21:35. Moreover, it is preferably that the sum of the first width W1, the second width W2, and the third width W3 is equal to the sum of the width of the three power lines with the same width design. Accordingly, the aperture ratio is not affected. That is to say, to compare with a comparative embodiment with a uni-width W, it is preferably that the first width W1, the second width W2, and the third width W3 in the embodiment of the present invention satisfy the relation of W1+W2+W3=3 W, such that the aperture ratio is unchanged. Furthermore, in the embodiment of the present invention, the difference between the first width W1 and the second width W2 is substantially equal to the difference between the second width W2 and the third width W3. For example, if the width W of one of the power lines of the comparative embodiment is 10 micrometers (μm), the first width W1 in the embodiment is 14 μm, the second width W2 is 10 μm, and the third width W3 is 6 μm.

If the resistance of the power line of the comparative embodiment with a width W (10 μm) is 21 r, the first resistance R1 of the first power line PL1 with the first width W1 (14 μm) will be 15 r, the second resistance R2 of the second power line PL2 with the second width W2 (10 μm) will be 21 r, and the third resistance R3 of the third power line PL3 with the third width W3 (6 μm) will be 35 r in the present embodiment. Moreover, if the current of the first power line PL1 is 3 A, the current of the second power line PL2 is 2 A, and the current of the third power line PL3 is 1 A, the total voltage dropping of the three uni-width power lines of the comparative embodiment will be 21 r*3 A+21 r*2 A+21 r*1 A=126 rA. On the other hand, the total voltage dropping of the first power line PL1, the second power line PL2, and the third power line PL3 of the embodiment of the present invention will be 15 r*3 A+21 r*2 A+35 r*1 A=122 rA. It could be testified that adjusting the width ratio of the first power line PL1, the second power line PL2 and the third power line PL3 of the embodiment of the present invention can effectively reduce the total voltage dropping of the electroluminescent display panel 30, and further improve the uniformity of the brightness.

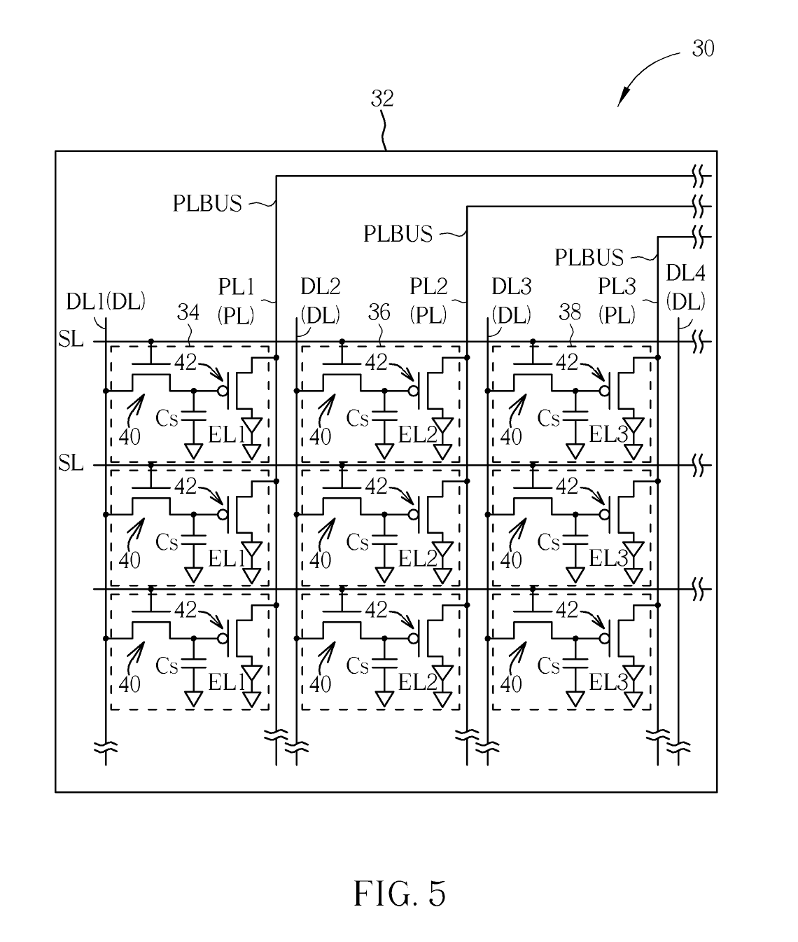

FIG. 5 illustrates an electroluminescent display panel of another preferred embodiment of the present invention. In order to compare the difference between the embodiments more easily and to describe briefly, same components are denoted by same numerals, and repeated parts are not redundantly described. As shown in FIG. 5, different from the embodiment mentioned above, the first power line PL1, the second power line PL2, and the third power line PL3 are electrically connected respectively to three power bus lines PLBUS, instead of electrically connecting the same power bus line. Also, the width of each power bus line PLBUS can be adjusted based on the different current requirements for the first power line PL1, the second power line PL2, and the third power line PL3. For example, three power bus lines PLBUS may have the same width or have the different widths based on the different current required by the first power line PL1, the second power line PL2, and the third power line PL3.

As mentioned above, the electroluminescent display panel and the pixel structure of the present invention have the power lines with different widths, wherein the power line with larger current has the larger width and the power line with the less current has the less width. Through the different width design mentioned above, it is effective to reduce the total voltage dropping of the power lines and to improve the uniformity of the brightness without affecting the aperture ratio.

Those skilled in the art will readily observe that numerous modifications and alterations of the device and method may be made while retaining the teachings of the invention.

What is claimed is:

1. An electroluminescent display panel, comprising:
a substrate;
a plurality of scanning lines disposed on the substrate, the scanning lines being arranged substantially in parallel to each other in a first direction;
a plurality of data lines disposed on the substrate, the data lines being arranged substantially in parallel to each other in a second direction, wherein the data lines and the scanning lines at least define a plurality of blue sub-pixel areas arranged in the second direction, a plurality of red sub-pixel areas arranged in the second direction, and a plurality of green sub-pixel areas arranged in the second direction on the substrate;
a plurality of electroluminescent devices, comprising:
a plurality of blue electroluminescent devices, disposed in the blue sub-pixel areas;
a plurality of red electroluminescent devices, disposed in the red sub-pixel areas; and
a plurality of green electroluminescent devices, disposed in the green sub-pixel areas; and
a plurality of power lines, comprising:
at least one first power line, disposed on the substrate in the second direction and electrically connected to the blue electroluminescent devices, wherein the first power line has a first width;
at least one second power line, disposed on the substrate in the second direction and electrically connected to the red electroluminescent devices, wherein the second power line has a second width; and
at least one third power line, disposed on the substrate in the second direction and electrically connected to the green electroluminescent devices, wherein the third power line has a third width;
wherein the first width is larger than the second width, and the first width is larger than the third width.

2. The electroluminescent display panel according to claim 1, wherein the blue electroluminescent device has a first light emitting efficiency, the red electroluminescent device has a second light emitting efficiency, and the green electroluminescent device has a third light emitting efficiency, the first light emitting efficiency is lower than the second light emitting efficiency, and the first light emitting efficiency is lower than the third light emitting efficiency.

3. The electroluminescent display panel according to claim 2, wherein the second light emitting efficiency is lower than the third light emitting efficiency.

4. The electroluminescent display panel according to claim 3, wherein the second width is larger than the third width.

5. The electroluminescent display panel according to claim 1, wherein a difference between the first width and the second width is substantially equal to a difference between the second width and the third width.

6. The electroluminescent display panel according to claim 1, wherein a ratio of the first width, the second width, and the third width substantially is 7:5:3.

7. The electroluminescent display panel according to claim 1, wherein the first power line has a first resistance, the second power line has a second resistance, and the third power line has a third resistance, the first resistance is lower than the second resistance, and the second resistance is lower than the third resistance.

8. The electroluminescent display panel according to claim 1, wherein the first power line, the second power line, and the third power line are electrically connected to a single power bus line.

9. The electroluminescent display panel according to claim 1, wherein the first power line, the second power line, and the third power line are electrically connected separately to three different power bus lines.

10. The electroluminescent display panel according to claim 1, further comprising a plurality of first switch device disposed in the blue sub-pixel areas, the red sub-pixel areas, and the green sub-pixel areas respectively, wherein a gate of each of the first switch device is electrically connected to the corresponding scanning line, and a source of each of the first switch device is electrically connected to the corresponding data line.

11. The electroluminescent display panel according to claim 10, further comprising a plurality of second switch devices, disposed separately in the blue sub-pixel areas, the red sub-pixel areas, and the green sub-pixel areas; wherein a gate of each of the second switch devices is electrically connected to a drain of the corresponding first switch device, a source of each of the second switch devices is electrically connected to the corresponding electroluminescent device, and the drain of each of the second switch devices is electrically connected to the corresponding power line.

12. A pixel structure, disposed on a substrate having a blue sub-pixel area, a red sub-pixel area, and a green sub-pixel area defined thereon, the pixel structure comprising:
a blue electroluminescent device, disposed in the blue sub-pixel area;
a red electroluminescent device, disposed in the red sub-pixel area;
a green electroluminescent device, disposed in the green sub-pixel area;
a first power line, disposed on the substrate and electrically connected to the blue electroluminescent device, wherein the first power line has a first width;
a second power line, disposed on the substrate and electrically connected to the red electroluminescent device, wherein the second power line has a second width; and
a third power line, disposed on the substrate and electrically connected to the green electroluminescent device, wherein the third power line has a third width;
wherein the first width is larger than the second width, and the first width is larger than the third width.

13. The pixel structure according to claim 12, wherein the blue electroluminescent device has a first light emitting efficiency, the red electroluminescent device has a second light emitting efficiency, and the green electroluminescent device has a third light emitting efficiency, the first light emitting efficiency is lower than the second light emitting efficiency, and the first light emitting efficiency is lower than the third light emitting efficiency.

14. The pixel structure according to claim 13, wherein the second light emitting efficiency is lower than the third light emitting efficiency.

15. The pixel structure according to claim 14, wherein the second width is larger than the third width.

16. The pixel structure according to claim 12, wherein a difference between the first width and the second width is substantially equal to a difference between the second width and the third width.

17. The pixel structure according to claim 12, wherein a ratio of the first width, the second width, and the third width is substantially 7:5:3.

18. The pixel structure according to claim 12, wherein the first power line has a first resistance, the second power line has a second resistance, and the third power line has a third resistance, the first resistance is lower than the second resistance, and the second resistance is lower than the third resistance.

19. The pixel structure according to claim 12, wherein the first power line, the second power line, and the third power line are electrically connected to a single power bus line.

20. The pixel structure according to claim 12, wherein the first power line, the second power line, and the third power line are electrically connected separately to three different power bus lines.

21. A pixel structure, disposed on a substrate having a first sub-pixel area, a second sub-pixel area, and a third sub-pixel area defined thereon, the pixel structure comprising:
a first electroluminescent device, disposed in the first sub-pixel area for emitting a first color light with a first wavelength;
a second electroluminescent device, disposed in the second sub-pixel area for emitting a second color light with a second wavelength;
a third electroluminescent device, disposed in the third sub-pixel area for emitting a third color light with a third wavelength;
a first power line, disposed on the substrate and electrically connected to the first electroluminescent device, wherein the first power line has a first width;
a second power line, disposed on the substrate and electrically connected to the second electroluminescent device, wherein the second power line has a second width; and
a third power line, disposed on the substrate and electrically connected to the third electroluminescent device, wherein the third power line has a third width;
wherein the first wavelength is less than the second wavelength, the first wavelength is less than the third wavelength, the first width is larger than the second width, and the first width is larger than the third width.

22. The pixel structure according to claim 21, wherein the first electroluminescent device has a first light emitting efficiency, the second electroluminescent device has a second light emitting efficiency, and the third electroluminescent device has a third light emitting efficiency, the first light emitting efficiency is lower than the second light emitting efficiency, and the first light emitting efficiency is lower than the third light emitting efficiency.
